(19) United States
(12) Patent Application Publication
(10) Pub. No.: US 2005/0220948 A1
(43) Pub. Date: Oct. 6, 2005

(54) Denatured spirulina and manufacturing method thereof

(75) Inventors: Byung-Hoon Han, Seoul (KR); Mi-Kyung Pyo, Seoul (KR); Su-Jin Yang, Kyeongki-do (KR)

Correspondence Address: BIRCH STEWART KOLASCH & BIRCH, PO BOX 747, FALLS CHURCH, VA, 22040-0747, US

(73) Assignee: ES BIOTECH CO., LTD, Chungcheongnam-do (KR)

(21) Appl. No.: 10/509,031

(22) PCT Filed: Mar. 24, 2003
(86) PCT No.: PCT/KR03/00569

§ 371 Date: Apr. 18, 2005

(30) Foreign Application Priority Data
Mar. 25, 2002 (KR) 10-2002-0016183

(51) Int. Cl. A23L 1/10

(52) U.S. Cl. 426/455; 426/615

(57) ABSTRACT

Disclosed is a denatured spirulina of being removed the unpleasant smell of spirulina, of maintaining its nutrients undestroyed, of being changed the unpleasant deep blue color from light blue to rose pink, and of showing higher suspensible nature to cold water, characterized in that spirulina is suspended in distilled or purified water to destroy its cell membranes by osmolytic treatment, so the chromoprotein phycocyanin leaks out of the cell membranes; chromoprotein in the spirulina is partially denatured by heating the resulting mixture; condensing, condensing under reduced pressure or finally freeze-dried the resulting mixture.

### TECHNICAL FIELD

The present invention relates to a denatured spirulina and a method of manufacturing the same.

Spirulina is a kind of microalgae propagating in the tropical alkaline lake-water of high salt concentration (Microbiologists classify them as a kind of cyanobacteria). The natives have collected these microalgae as food for a long time. Nutritional studies show that spirulina contains high contents of protein having well balanced amino acid composition together with other nutritional components well adapted for human health. This is often called a perfect food since it has the nutrient compositions so well balanced that there is no possibility of health troubles due to the mechanism of unbalanced diet even when only spirulina is taken for a long time. Presently spirulina is being reputed highly as a health food because standardized food grade products are supplied by well-established culture techniques. It is a well-known facts that spirulina is a super food, which could improve various adult diseases and also correct nutritional defect states by the long-term intake of spirulina. Spirulina is also well known as a super food, which would be beneficial for pregnant women as well as for growing young ages and rehabilitation of patients.

On the other hand, the studies on the product development for spilulina were not so much progressed even in the advanced countries that only for tablets and some preparations of spirulina extract are available. At present, liquid form preparations such as drink or instant form for drink is not available even though higher demand for the liquid form of spirulina would be expected. It would be very convenient if we could easily mix spirulina powder with hot or cold water, or with milk however, sapirulina powder is not well dispersed in water sticking to spoon and glass wall. This property of spirulina is one of impeding factors limiting the wide distribution of spirulina for the improvement of human health. Using some artificial synthetic surfactant for the dispersion of spirulina in aqueous media will not be recommended, since mixing such chemicals as artificial surfactant in food may results in harmful effects to human health. Additionally, a slightly bad smell and deep blue sticking to mouth and teeth induced repugnance toward the intake of spirulina.

### BACKGROUND ART

The known methods of destroying cell membranes in order to make water-soluble spirulina include (1) mechanical grinding with glass homogenizer, (2) destruction of cell membranes by supersonic wave treatment, and (3) dissolution of cells by successive treatments of various enzymes such as lysozyme and other digestive enzymes. However, the method (1) is inefficient for destroying cell membranes, hence low value for industrial application, the method (2) has a high opportunity of microbial contamination during long supersonic wave treatment time, and the method (3) is not only appropriate for popularization of drinks since the enzyme hydrolysate tastes repugnant, but also has many problems in connection with industrialization since the condition of enzyme reactions is optimal for contaminating microbial growth.

The present inventors tried to obtain denatured spirulina that will well disperse to aqueous media by changing the physical property of spirulina powder without mixing any foreign surfactant and using already known cell lysing process. This new cell denaturing process ensures no change of nutritional constituents of spirulina, thereby removing disagreeable smell and finding a way out of the repugnant appearance due to the deep blue color.

### DISCLOSURE OF INVENTION

The present inventors could understand the reasons why the spirulina is not dispersed in aqueous media as followings:
1) Spirulina has hydrophobicity due to the lipoprotein in the cell membrane;
2) Spirulina powder is surrounded by the micro bubbles of oxygen gas that has formed due to its active photosynthetic process.
3) As spirulina is an microorganism which is well grown in water of high salt concentration and when the spirulina is dispersed in distilled water, the cell membranes are destroyed due to osmotic pressure. Therefore, as proteins in cells are outflown, the cells can be uniformly suspended without addition of surfactant.
4) When the spirulina which is not suspended and floated in the entangled state each other is deaerated under reduced pressure, the microbubbles of oxygen gas is eliminated and uniform suspension is obtained/
5) The deep blue of the spirulina is due to chromoprotain called phycocyanin contained therein.

In order to combat to the above two obstructive factors it was felt that deaeration under the presence of non-artificial surfactant solution will be necessary. We know that spirulina is growing in the media of higher salt concentration. This fact suggest that isotonic salt concentration of spirulina must be very high.

Based on this understanding the inventors tried to rupture the cell membranes of spirulina by simply placing it in distilled water for a while. Fortunately, our assumption was exactly correct and we could observe that the deep blue of phycocyanin component of spirulina was leaking out from spirulina cell due to osmotic rupture of cell membranes by simply placing spirulina in distilled water. Phycocyanin pigment is chromprotein whose content in spirulina has been known to be more than 10% of total spirulina mass. After one to three hours, spirulina suspension turned out to be deep blue solution due to complete rupture of cell membranes. The solution was subjected to deaeration by reducing the pressure in a closed chamber to obtain the spirulina solution in which the cell debris must be completely impregnated with surface active chromoprotein. It is well known facts that proteins including chromoproteins in spirulina have surface-active property.

We found a remarkable fact that if this chromoprotein is denatured by heating to 70 to 100° C., the deep blue color changes to light blue and finally to rose pink depending on the heating temperature and time length. Finally, we could obtain denatured spirulina powder by freeze-drying of the cell membrane ruptured spirulina solution. The denatured spirulina powder showed good solubility or dispersability in cold water, hence the invention was completely successful.

Meanwhile, an object of the present invention is to provide a denatured spirulina that is well suspended in water, tastes good, and changed in color to light blue or rose pink, by rupturing spirulina cell membrane with the treatments consisting of impregnation in distilled water, heat treatment, deaeration and finally freeze-drying process.

Sometimes, deaeration meets some troubles due to foaming under reduced pressure. This trouble could be easily managed by adding some low molecular alcohols as ethanol, propanol or butanol as defoaming agent in the deaeration step.

To the deaerated spirulina suspension, some additive agents selected from the lists of sweetening agents, flavoring agents, and preservative agents could be added to make such commercial products as liquid form preparations, tablets, or capsules.

The denatured spirulina of the present invention may be added to foods or food additives.

### BEST MODE FOR CARRYING OUT THE INVENTION

Followings are detailed description of embodiments of present invention.

### EXAMPLE 1

5 g of spirulina was mixed with 100 ml of distilled water and placed in a dark cool place for 1 hour to destroy the cell membranes of spirulina due to osmolytic mechanism. The spirulina slurry becomes blue due to leaking out of phycocyanin pigment Resulting mixture was heated at 70 to 75° C. for 10 minutes to reduce deep blue into light blue due to partial denaturation of phycocyanin chromoprotein. The mixture was then deaerated by reducing pressure in a closed chamber. As deaeration occurs, spirulina becomes a homogeneous suspension, which was then freeze-dried to obtain 5 g of crumbly dry powder of spirulina. This spirulina powder does not contain any foreign materials, and except for the denaturation of the chromoprotein, no change or destruction has taken place in the nutrient compositions. Hygienically it will be safe, since any harmful microbes must be sterilized due to heat treatment during the invented process. The crumbly spirulina powder made in this way could be mixed well with water or milk, and the resulting homogeneous suspension did not taste unpleasant. The suspension lost the repugnant deep blue color and turned sky-blue or green depending on the depth of heat treatment. The unpleasant seaweed like smell diminished considerably and it was confirmed that spirulina was denatured to become a suitable material for the preparation of liquid form foods.

### EXAMPLE 2

5 g of spirulina was mixed well with 50 ml of distilled water and treated as in Example 1 except that the heating time was shortened to 5 minutes, and were freeze-dried to obtain the final product Resulting denatured spirulina showed same properties with that obtained by Example-1.

### EXAMPLE 3

50 g of spirulina was added to 50 ml of purified water and was treated as in Example 2 except that a small amount of butanol was added immediately before deaeration to prevent foaming due to deaeration process. Resulting denatured spirulina showed similar properties as previous one.

### EXAMPLE 4

50 g of Spirulina was mixed with 50 ml distilled water and was treated as in Example 2, except that a small amount of ethanol was added instead of butanol. The resulting denatured spirulina showed similar properties as that of previous one.

### EXAMPLE 5

50 g of Spirulina were added to 50 ml of purified water and were treated as in Example 1. Then a small amount of butanol was added and the resulting material was treated as in Example 2, and freeze-dried after deaeration to obtain 50 g of denatured spirulina.

### EXAMPLE 6

5 g of Spirulina was mixed well with 100 ml of distilled water, and placed in a dark cool place for 1 hour to destroy the cell membranes of spirulina The chromoprotein pycocyanin leaked out of the cell membranes to turn deep blue. The resulting mixture was heated at 90 to 100° C. for about 10 minutes to reduce blue color to light blue to rose pink due to denaturation of phycocyanin and spirulina became a homogeneous suspension, which was freeze-dried to obtain 5 g of crumbly dry powder of spirulina.

### FORMULATION EXAMPLE 1

| | |
|---|---|
| Denatured spirulina of Example 1 | 500 mg |
| Starch | 100 mg |
| Lactose | 100 mg |
| Magnesium Sterate | proper amount |

The above compositions were filled in a gelatin capsule using general capsule manufacturing methods.

### FORMULATION EXAMPLE 2

| | |
|---|---|
| Denatured spirulina of Example 1 | 500 mg |
| Starch | 300 mg |
| Lactose | 200 mg |
| Magnesium Sterate | proper amount |
| Talc | proper amount |

The above compositions were made a tablet using general tablet manufacturing methods.

### FORMULATION EXAMPLE 3

| | |
|---|---|
| Denatured spirulina of Example 3 | 3 g |
| Inverted sugar | 5 g |
| Sodium Alginate | 50 mg |
| Sodium Benzoate | proper amount |
| Purified water | proper amount |

The above compositions were filled in a brown bottle to manufacture a suspension using general suspension manufacturing methods.

### FORMULATION EXAMPLE 4

| | | |
|---|---|---|
| Milk | 100 | ml |
| Denatured spirulina of Example 1 | 3 | g |

The denatured spirulina was added to milk to manufacture spirulina-added milk.

### FORMULATION EXAMPLE 5

5 g of the denatured spirulina was added to 100 g of flour dough, to which yeast and other additives were added, and was mixed well and heated in the oven to manufacture the spirulina added bread containing denatured spirulina.

### INDUSTRIAL APPLICABILITY

In this invention, spirulina is mixed well with small amount of distilled water to destroy the cell membrane by treatment with hypotonic osmolytic mechanism. The surface-active proteinous pigment of spirulina is leaked out of cell membrane to coat hydrophobic cell membranes. This mechanism enables the hydrophobic spirulina powder to become hydrophilic. After deaeration and freeze-drying process, denatured spirulina powder is obtained. This denatured spirulina has several advantages in that spirulina specific seaweed like smell is seriously diminished, its deep blue color could be moderately changed and could be easily suspended to cold water. These denatured properties of spirulina will be suitable for the preparation of various liquid form foods.

1. A denatured spirulina of being removed the unpleasant smell of spirulina, of maintaining its nutrients undestroyed, of being changed the unpleasant deep blue color to from light blue to rose pink, and of showing higher suspensible nature to cold water characterized in that spirulina is suspended in distilled or purified water to destroy its cell membranes by osmolytic treatment, so the chromoprotein phycocyanin leaks out of the cell membranes; chromoprotein in the spirulina is partially denatured by heating the resulting mixture; condensing, condensing under reduced pressure or finally freeze-dried the resulting mixture.

2. A denatured spirulina of being removed the unpleasant smell of spirulina, of maintaining its nutrients undestroyed, of being changed the unpleasant deep blue color to from light blue to rose pink, and of showing higher suspensible nature to cold water characterized in that spirulina is suspended in distilled or purified water to destroy its cell membranes by osmolytic treatment, so the chromoprotein phycocyanin leaks out of the cell membranes; the mixture is deaerated by reducing pressure in a closed chamber; chromoprotein in the spirulina is partially denatured by heating the resulting mixture; condensing, condensing under reduced pressure or finally freeze-dried the resulting mixture.

3. A denatured spirulina of being removed the unpleasant smell of spirulina, of maintaining its nutrients undestroyed, of being changed the unpleasant deep blue color to from light blue to rose pink, and of showing higher suspensible nature to cold water of claim 1 or 2, wherein the spirulina is treated at from 60° C. to 130° C.

4. A denatured spirulina of being removed the unpleasant smell of spirulina, of maintaining its nutrients undestroyed, of being changed the unpleasant deep blue color to from light blue to rose pink, and of showing higher suspensible nature to cold water of claim 1 or 2, wherein a small amount of C₁-C₄ lower alcohol is added to prevent foaming at the time of deaeration.

5. A food additive or food, to which denatured spirulina of being removed the unpleasant smell of spirulina, of maintaining its nutrients undestroyed, of being changed the unpleasant deep blue color to from light blue to rose pink, and of showing higher suspensible nature to cold water is added.

6. A manufacturing process for the preparation of denatured spirulina of being removed the unpleasant smell of spirulina, of maintaining its nutrients undestroyed, of being changed the unpleasant deep blue color to from light blue to rose pink, and of showing higher suspensible nature to cold water characterized in that spirulina is suspended in distilled or purified water to destroy its cell membranes by osmolytic treatment, so the chromoprotein phycocyanin leaks out of the cell membranes; chromoprotein in the spirulina is partially denatured by heating the resulting mixture; condensing, condensing under reduced pressure or finally freeze-dried the resulting mixture.

7. A manufacturing process for the preparation of denatured spirulina of being removed the unpleasant smell of spirulina, of maintaining its nutrients undestroyed, of being changed the unpleasant deep blue color to from light blue to rose pink, and of showing higher suspensible nature to cold water characterized in that spirulina is suspended in distilled or purified water to destroy its cell membranes by osmolytic treatment, so the chromoprotein phycocyanin leaks out of the cell membranes; the mixture is deaerated by reducing pressure in a closed chamber; chromoprotein in the spirulina is partially denatured by heating the resulting mixture; condensing, condensing under reduced pressure or finally freeze-dried the resulting mixture.

8. A manufacturing process for the preparation of denatured spirulina of being removed the unpleasant smell of spirulina, of maintaining its nutrients undestroyed, of being changed the unpleasant deep blue color to from light blue to rose pink, and of showing higher suspensible nature to cold water of claim 6 or 7, wherein the spirulina is treated with heat at from 60° C. to 13° C.

9. A manufacturing process for the preparation of denatured spirulina of being removed the unpleasant smell of spirulina, of maintaining its nutrients undestroyed, of being changed the unpleasant deep blue color to from light blue to rose pink, and of showing higher suspensible nature to cold water of claim 7, wherein a small amount of C₁-C₄ lower alcohol is added to prevent foaming at the time of deaeration.
